(19) United States
(12) Patent Application Publication
(10) Pub. No.: US 2025/0217989 A1
(43) Pub. Date: Jul. 3, 2025

(54) CENTROID PREDICTION USING SEMANTICS AND SCENE CONTEXT

(71) Applicant: GM Cruise Holdings LLC, San Francisco, CA (US)

(72) Inventors: Zhe Wang, San Francisco, CA (US); Yichen Shen, Santa Clara, CA (US)

(21) Appl. No.: 18/402,368

(22) Filed: Jan. 2, 2024

(51) Int. Cl. G06T 7/11; G01S 17/89; G06T 7/60

(52) U.S. Cl. CPC G06T 7/11; G01S 17/89; G06T 7/60; G06T 2207/10024; G06T 2207/10028; G06T 2207/20081; G06T 2207/20084; G06T 2207/30252

(57) ABSTRACT

The present disclosure generally relates to improved centroid predictions. In some aspects, a method of the disclosed technology includes: collecting, from a sensor, sensor data comprising data points; segmenting, via a first network, the sensor data into a first portion of the sensor data and a second portion of the sensor data; determining a semantic label for the first portion of the sensor data; determining local semantic information for each data point of the first portion of the sensor data; removing, using a point mask, the second portion of the sensor data; and determining, via a second network, a centroid of the first portion of the sensor data based on the first portion of the sensor data, the semantic label, and the local semantic information. Systems and machine-readable media are also provided.

### BACKGROUND

### 1. Technical Field

The present disclosure generally relates to improved centroid predictions and, more specifically, improving a centroid prediction of a target object detected by one or more sensors by leveraging data outputs from a segmentation network and providing the data to a centroid network.

### 2. Introduction

Sensors are commonly integrated into a wide array of systems and electronic devices such as, for example, camera systems, mobile phones, autonomous systems (e.g., autonomous vehicles, unmanned aerial vehicles or drones, autonomous robots, etc.), computers, smart wearables, and many other devices. The sensors allow users to obtain sensor data that measures, describes, and/or depicts one or more aspects of a target such as an object, a scene, a person, and/or any other targets. For example, a time-of-flight (TOF) sensor can be used to measure distance to one or more objects in an environment. As another example, a light ranging and detection (LIDAR) sensor can be used to determine ranges (variable distance) of one or more targets by directing a laser to a surface of an entity (e.g., a person, an object, a structure, an animal, etc.) and measuring the time for light reflected from the surface to return to the LIDAR. In some cases, a LIDAR (e.g., a spinning LIDAR) can be configured to rotate about an axis of the LIDAR in order to collect LIDAR data during a rotation of the LIDAR, such as a full rotation (e.g., 360 degrees) or a partial rotation of the LIDAR. The rotation of the LIDAR can allow the LIDAR to achieve a larger field-of-view (FOV) and thus collect revolutions of LIDAR data that have a greater area of coverage.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates an example system environment that can be used to facilitate autonomous vehicle (AV) dispatch and operations, according to some aspects of the disclosed technology;

FIG. 2 illustrates a diagram of an example system for improving a centroid prediction of a target object detected by one or more sensors, according to some examples of the present disclosure;

FIG. 3 illustrates a diagram of an example system for processing point cloud data by a segmentation network, according to some examples of the present disclosure;

FIG. 4 illustrates a diagram of an example system for processing point cloud data by a centroid predication network, according to some examples of the present disclosure;

FIG. 5 illustrates a flow diagram of an example process for improving a centroid prediction of a target detected by one or more sensors, according to some examples of the present disclosure;

FIG. 6 illustrates an example of a deep learning neural network that can be used to segment data and/or predict a centroid of a target object, according to some aspects of the disclosed technology; and

FIG. 7 illustrates an example processor-based system with which some aspects of the subject technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form to avoid obscuring the concepts of the subject technology.

Some aspect of the present technology may relate to the gathering and use of data available from various sources to improve safety, quality, and experience. The present disclosure contemplates that in some instances, this gathered data may include personal information. The present disclosure contemplates that the entities involved with such personal information respect and value privacy policies and practices.

As discussed above, sensors are commonly integrated into a wide array of systems and electronic devices such as, for example, camera systems, mobile phones, autonomous systems (e.g., autonomous vehicles, unmanned aerial vehicles or drones, autonomous robots, etc.), computers, smart wearables, and many other devices. The sensors allow users to obtain sensor data that measures, describes, and/or depicts one or more aspects of a target such as an object, a scene, a person, and/or any other targets. Various sensors can include, but are not limited to, camera sensors, light ranging and detection (LIDAR) sensors, radio detection and ranging (RADAR) sensors, sound navigation and ranging (SONAR) sensors, inertial measurement unit (IMU) sensors, and/or any other sensors.

In one illustrative example, a LIDAR sensor can be used to determine ranges (variable distance) of one or more targets by directing a laser to a surface of a target (e.g., a person, an object, a structure, an animal, etc.) and measuring the time for light reflected from the surface to return to the LIDAR sensor. In some cases, a LIDAR sensor, such as a spinning LIDAR sensor, can be configured to rotate about an axis of the LIDAR sensor while collecting sensor data for different regions of space. The rotation of the LIDAR sensor can allow the LIDAR sensor to achieve a larger field-of-regard (FOR) based on the field-of-view (FOV) of the LIDAR sensor from different positions during a scan cycle, and thus collect revolutions of sensor data that have a greater area of coverage. This raw sensor data collected by the LIDAR sensor can comprise LIDAR point cloud data that can be analyzed by one or more computing systems or networks to make determinations about the size, shape, and location of the one or more targets (among other determinations). For example, a computing system or network can determine a location (e.g., x, y, z coordinates in space) of one or more targets by analyzing and processing received raw HD LIDAR point cloud sensor data. Additionally, the shape of the one or more targets can be modeled by a computing system or network based on the received raw HD LIDAR point cloud sensor data.

For example, as described in more detail below, data from a sensor, such as raw LIDAR point cloud sensor data, can be used to perform object detection and implement associated algorithms. In one example, an autonomous vehicle (AV) can collect sensor data and analyze the sensor data to perform various tasks such as object detection, tracking, object recognition, prediction tasks, and/or planning tasks, among others. The AV can implement one or more algorithms used to perform object detection (and/or implemented as part of the object detection). For example, an object detection algorithm can generate one or more bounding boxes around a region of a point cloud estimated to correspond to the target object located within the point cloud data. In some examples, the object detection algorithm can be a 2D object detection algorithm. While this example is presented in the context of an AV, the techniques explained herein are also applicable to sensors in communication with a wide array of systems and electronic devices such as, for example, camera systems, mobile phones, other autonomous systems (e.g., unmanned aerial vehicles or drones, autonomous robots, etc.), computers, smart wearables, and many other devices.

In some examples, the bounding box determined by the object detection algorithm (including the point cloud data points located within the bounding box) can be provided to a segmentation network to further process the LIDAR point cloud sensor data. The bounding box applied by the object detection algorithm can include point cloud sensor data points that do not correspond to the target object (such as point cloud sensor data points corresponding to the background). In some scenarios, this can occur since the bounding box can be a rectangular shape, while many detected objects are not perfectly rectangular. Therefore, some point cloud sensor data points located within a bounding box may not correspond to the intended target object located within the bounding box. A segmentation network can provide several functions, as described in more detail below, including segmenting the received point cloud data points to determine which point cloud data points correspond to the target object and which point cloud data points do not correspond to the target object. The segmentation network can output the point cloud data points corresponding to the target object (in addition to other outputs) for subsequent processing by other algorithms and networks. This removal of point cloud data points that do not correspond to the target object can improve the speed, efficiency, and accuracy of subsequent operations performed on the point cloud data points.

A centroid network is another network that can analyze and process point cloud data points located within the determined bounding box. For example, a centroid network can process raw point cloud data points corresponding to a target object within a bounding box to determine a centroid of the target object. A centroid of a target object can be the three-dimensional center point of a target object and can be useful in subsequent tracking, object recognition, prediction tasks, and/or planning tasks, among other processes. However, in some examples, due to the limitations of the shape of the bounding box and/or the shape of the target object (as discussed above), the point cloud data points provided to the centroid network can include extraneous data points that do not correspond to the target object. Therefore, in some cases, the location of the centroid of a target object determined by the centroid network can be incorrect (for example, when the centroid network includes data points in the calculation that do not correspond to the target object). An incorrectly calculated centroid can negatively affect subsequent operations such as tracking, object recognition, prediction tasks, and/or planning tasks, and others.

Described herein are systems, apparatuses, processes (also referred to as methods), and computer-readable media (collectively referred to as “systems and techniques”) for improving a centroid prediction of a target object detected by one or more sensors by leveraging data outputs from a segmentation network and providing the data to a centroid network. While the illustrative examples described below are presented in the context of an AV, the systems and techniques explained herein are also applicable to other use cases and applications, including use cases and applications with sensors in communication with any type of system and/or electronic device such as, for example, a camera system, a mobile phone, other autonomous systems (e.g., an unmanned aerial vehicle or drone, autonomous robot, etc.), a computer, a smart wearable, and/or any other device.

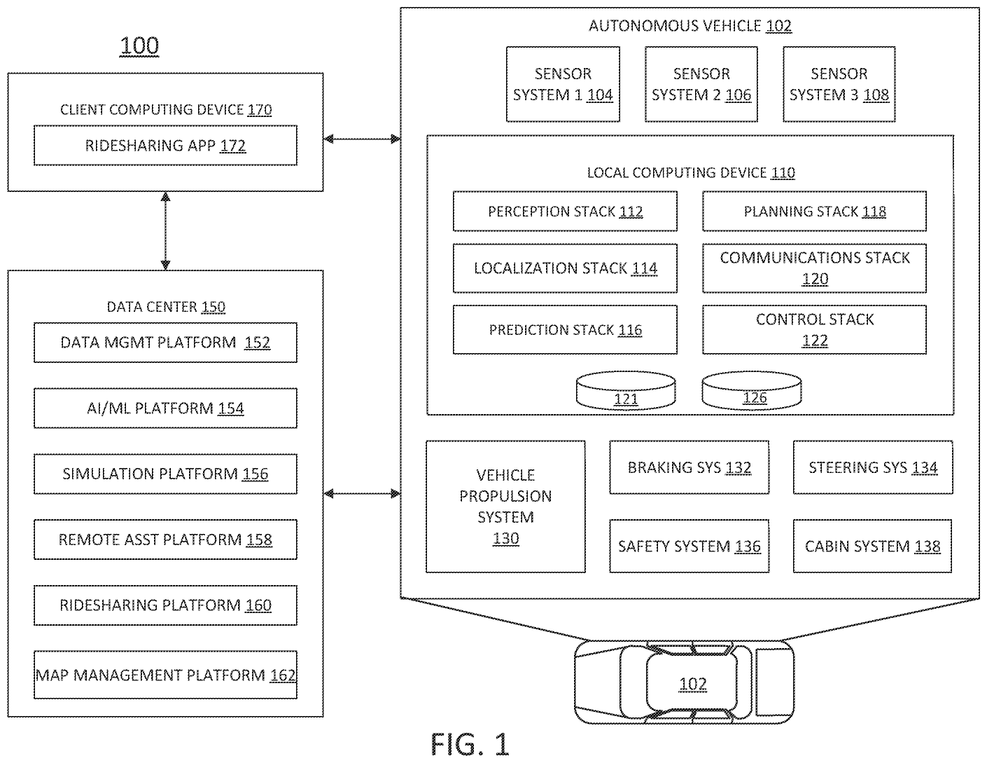

FIG. 1 is a diagram illustrating an example autonomous vehicle (AV) environment 100, according to some examples of the present disclosure. One of ordinary skill in the art will understand that, for AV environment 100 and any system discussed in the present disclosure, there can be additional or fewer components in similar or alternative configurations. The illustrations and examples provided in the present disclosure are for conciseness and clarity. Other examples may include different numbers and/or types of elements, but one of ordinary skill the art will appreciate that such variations do not depart from the scope of the present disclosure. In some aspects, the systems and techniques described herein for improving a centroid prediction of a target object can be implemented in the context of an autonomous vehicle, such as autonomous vehicle environment 100 shown in FIG. 1.

In this example, the AV environment 100 includes an AV 102, a data center 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 102 can navigate roadways without a human driver based on sensor signals generated by multiple sensor systems 104, 106, and 108. The sensor systems 104-108 can include one or more types of sensors and can be arranged about the AV 102. For instance, the sensor systems 104-108 can include Inertial Measurement Units (IMUs), cameras (e.g., still image cameras, video cameras, etc.), light sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 can be a camera system, the sensor system 106 can be a LIDAR system, and the sensor system 108 can be a RADAR system. Other examples may include any other number and type of sensors.

The AV 102 can also include several mechanical systems that can be used to maneuver or operate the AV 102. For instance, the mechanical systems can include a vehicle propulsion system 130, a braking system 132, a steering system 134, a safety system 136, and a cabin system 138, among other systems. The vehicle propulsion system 130 can include an electric motor, an internal combustion engine, or both. The braking system 132 can include an engine brake, brake pads, actuators, and/or any other suitable componentry configured to assist in decelerating the AV 102. The steering system 134 can include suitable componentry configured to control the direction of movement of the AV 102 during navigation. The safety system 136 can include lights and signal indicators, a parking brake, airbags, and so forth. The cabin system 138 can include cabin temperature control systems, in-cabin entertainment systems, and so forth. In some examples, the AV 102 might not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

The AV 102 can include a local computing device 110 that is in communication with the sensor systems 104-108, the mechanical systems 130-138, the data center 150, and the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV's environment; logging metrics collected by the sensor systems 104-108; and so forth. In this example, the local computing device 110 includes a perception stack 112, a localization stack 114, a prediction stack 116, a planning stack 118, a communications stack 120, a control stack 122, an AV operational database 124, and an HD geospatial database 126, among other stacks and systems.

Perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the localization stack 114, the HD geospatial database 126, other components of the AV, and other data sources (e.g., the data center 150, the client computing device 170, third party data sources, etc.). The perception stack 112 can detect and classify objects and determine their current locations, speeds, directions, and the like. In addition, the perception stack 112 can determine the free space around the AV 102 (e.g., to maintain a safe distance from other objects, change lanes, park the AV, etc.). The perception stack 112 can identify environmental uncertainties, such as where to look for moving objects, flag areas that may be obscured or blocked from view, and so forth. In some examples, an output of the perception stack 112 can be a bounding area around a perceived object that can be associated with a semantic label that identifies the type of object that is within the bounding area, the kinematic of the object (information about its movement), a tracked path of the object, and a description of the pose of the object (its orientation or heading, etc.).

Localization stack 114 can determine the AV's position and orientation (pose) using different methods from multiple systems (e.g., GPS, IMUs, cameras, LIDAR, RADAR, ultrasonic sensors, the HD geospatial database 126, etc.). For example, in some cases, the AV 102 can compare sensor data captured in real-time by the sensor systems 104-108 to data in the HD geospatial database 126 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

Prediction stack 116 can receive information from the localization stack 114 and objects identified by the perception stack 112 and predict a future path for the objects. In some examples, the prediction stack 116 can output several likely paths that an object is predicted to take along with a probability associated with each path. For each predicted path, the prediction stack 116 can also output a range of points along the path corresponding to a predicted location of the object along the path at future time intervals along with an expected error value for each of the points that indicates a probabilistic deviation from that point.

Planning stack 118 can determine how to maneuver or operate the AV 102 safely and efficiently in its environment. For example, the planning stack 118 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 102 from one point to another and outputs from the perception stack 112, localization stack 114, and prediction stack 116. The planning stack 118 can determine multiple sets of one or more mechanical operations that the AV 102 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 118 can select from multiple backup plans to carry out. For example, while preparing to change lanes to turn right at an intersection, another vehicle may aggressively cut into the destination lane, making the lane change unsafe. The planning stack 118 could have already determined an alternative plan for such an event. Upon its occurrence, it could help direct the AV 102 to go around the block instead of blocking a current lane while waiting for an opening to change lanes.

Control stack 122 can manage the operation of the vehicle propulsion system 130, the braking system 132, the steering system 134, the safety system 136, and the cabin system 138. The control stack 122 can receive sensor signals from the sensor systems 104-108 as well as communicate with other stacks or components of the local computing device 110 or a remote system (e.g., the data center 150) to effectuate operation of the AV 102. For example, the control stack 122 can implement the final path or actions from the multiple paths or actions provided by the planning stack 118. This can involve turning the routes and decisions from the planning stack 118 into commands for the actuators that control the AV's steering, throttle, brake, and drive unit.

Communications stack 120 can transmit and receive signals between the various stacks and other components of the AV 102 and between the AV 102, the data center 150, the client computing device 170, and other remote systems. The communications stack 120 can enable the local computing device 110 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). Communications stack 120 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Low Power Wide Area Network (LPWAN), Bluetooth®, infrared, etc.).

The HD geospatial database 126 can store HD maps and related data of the streets upon which the AV 102 travels. In some examples, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include three-dimensional (3D) attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

AV operational database 124 can store raw AV data generated by the sensor systems 104-108, stacks 112-122, and other components of the AV 102 and/or data received by the AV 102 from remote systems (e.g., the data center 150, the client computing device 170, etc.). In some examples, the raw AV data can include HD LIDAR point cloud data, image data, RADAR data, GPS data, and other sensor data that the data center 150 can use for creating or updating AV geospatial data or for creating simulations of situations encountered by AV 102 for future testing or training of various machine learning algorithms that are incorporated in the local computing device 110.

Data center 150 can include a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and/or any other network. The data center 150 can include one or more computing devices remote to the local computing device 110 for managing a fleet of AVs and AV-related services. For example, in addition to managing the AV 102, the data center 150 may also support a ride-hailing service (e.g., a ridesharing service), a delivery service, a remote/roadside assistance service, street services (e.g., street mapping, street patrol, street cleaning, street metering, parking reservation, etc.), and the like.

Data center 150 can send and receive various signals to and from the AV 102 and the client computing device 170. These signals can include sensor data captured by the sensor systems 104-108, roadside assistance requests, software updates, ride-hailing/ridesharing pick-up and drop-off instructions, and so forth. In this example, the data center 150 includes a data management platform 152, an Artificial Intelligence/Machine Learning (AI/ML) platform 154, a simulation platform 156, a remote assistance platform 158, and a ride-hailing platform 160, and a map management platform 162, among other systems.

Data management platform 152 can be a “big data” system capable of receiving and transmitting data at high velocities (e.g., near real-time or real-time), processing a large variety of data and storing large volumes of data (e.g., terabytes, petabytes, or more of data). The varieties of data can include data having different structures (e.g., structured, semi-structured, unstructured, etc.), data of different types (e.g., sensor data, mechanical system data, ride-hailing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), and/or data having other characteristics. The various platforms and systems of the data center 150 can access data stored by the data management platform 152 to provide their respective services.

The AI/ML platform 154 can provide the infrastructure for training and evaluating machine learning algorithms for operating the AV 102, the simulation platform 156, the remote assistance platform 158, the ride-hailing platform 160, the map management platform 162, and other platforms and systems. Using the AI/ML platform 154, data scientists can prepare data sets from the data management platform 152; select, design, and train machine learning models; evaluate, refine, and deploy the models; maintain, monitor, and retrain the models; and so on.

Simulation platform 156 can enable testing and validation of the algorithms, machine learning models, neural networks, and other development efforts for the AV 102, the remote assistance platform 158, the ride-hailing platform 160, the map management platform 162, and other platforms and systems. Simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from a cartography platform (e.g., map management platform 162); modeling the behavior of other vehicles, bicycles, pedestrians, and other dynamic elements; simulating inclement weather conditions, different traffic scenarios; and so on.

Remote assistance platform 158 can generate and transmit instructions regarding the operation of the AV 102. For example, in response to an output of the AI/ML platform 154 or other system of the data center 150, the remote assistance platform 158 can prepare instructions for one or more stacks or other components of the AV 102.

Ride-hailing platform 160 can interact with a customer of a ride-hailing service via a ride-hailing application 172 executing on the client computing device 170. The client computing device 170 can be any type of computing system such as, for example and without limitation, a server, desktop computer, laptop computer, tablet computer, smartphone, smart wearable device (e.g., smartwatch, smart eyeglasses or other Head-Mounted Display (HMD), smart ear pods, or other smart in-ear, on-ear, or over-ear device, etc.), gaming system, or any other computing device for accessing the ride-hailing application 172. The client computing device 170 can be a customer's mobile computing device or a computing device integrated with the AV 102 (e.g., the local computing device 110). The ride-hailing platform 160 can receive requests to pick up or drop off from the ride-hailing application 172 and dispatch the AV 102 for the trip.

Map management platform 162 can provide a set of tools for the manipulation and management of geographic and spatial (geospatial) and related attribute data. The data management platform 152 can receive LIDAR point cloud data, image data (e.g., still image, video, etc.), RADAR data, GPS data, and other sensor data (e.g., raw data) from one or more AVs 102, Unmanned Aerial Vehicles (UAVs), satellites, third-party mapping services, and other sources of geospatially referenced data. The raw data can be processed, and map management platform 162 can render base representations (e.g., tiles (2D), bounding volumes (3D), etc.) of the AV geospatial data to enable users to view, query, label, edit, and otherwise interact with the data. Map management platform 162 can manage workflows and tasks for operating on the AV geospatial data. Map management platform 162 can control access to the AV geospatial data, including granting or limiting access to the AV geospatial data based on user-based, role-based, group-based, task-based, and other attribute-based access control mechanisms. Map management platform 162 can provide version control for the AV geospatial data, such as to track specific changes that (human or machine) map editors have made to the data and to revert changes when necessary. Map management platform 162 can administer release management of the AV geospatial data, including distributing suitable iterations of the data to different users, computing devices, AVs, and other consumers of HD maps. Map management platform 162 can provide analytics regarding the AV geospatial data and related data, such as to generate insights relating to the throughput and quality of mapping tasks.

In some embodiments, the map viewing services of map management platform 162 can be modularized and deployed as part of one or more of the platforms and systems of the data center 150. For example, the AI/ML platform 154 may incorporate the map viewing services for visualizing the effectiveness of various object detection or object classification models, the simulation platform 156 may incorporate the map viewing services for recreating and visualizing certain driving scenarios, the remote assistance platform 158 may incorporate the map viewing services for replaying traffic incidents to facilitate and coordinate aid, the ride-hailing platform 160 may incorporate the map viewing services into the client application 172 to enable passengers to view the AV 102 in transit en route to a pick-up or drop-off location, and so on.

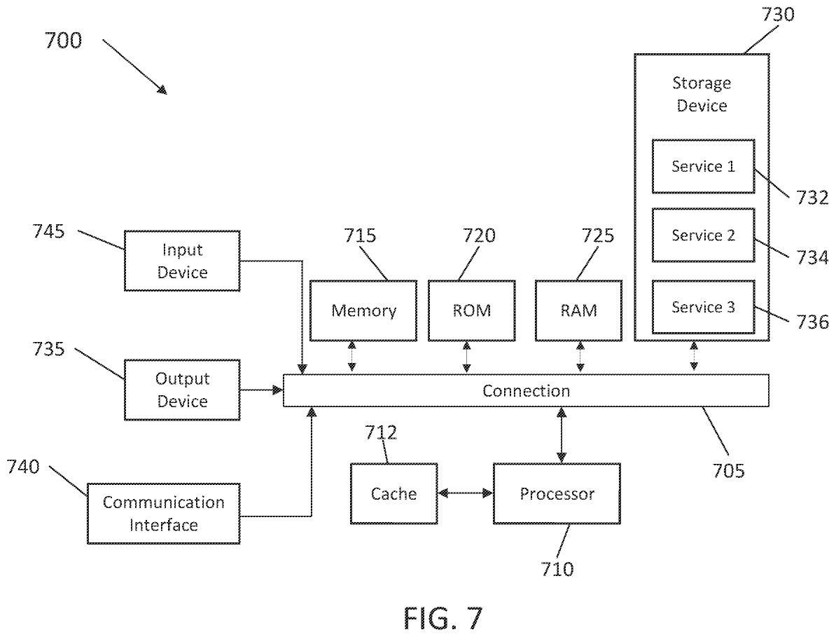

While the autonomous vehicle 102, the local computing device 110, and the autonomous vehicle environment 100 are shown to include certain systems and components, one of ordinary skill will appreciate that the autonomous vehicle 102, the local computing device 110, and/or the autonomous vehicle environment 100 can include more or fewer systems and/or components than those shown in FIG. 1. For example, the autonomous vehicle 102 can include other services than those shown in FIG. 1 and the local computing device 110 can also include, in some instances, one or more memory devices (e.g., RAM, ROM, cache, and/or the like), one or more network interfaces (e.g., wired and/or wireless communications interfaces and the like), and/or other hardware or processing devices that are not shown in FIG. 1. An illustrative example of a computing device and hardware components that can be implemented with the local computing device 110 is described below with respect to FIG. 7.

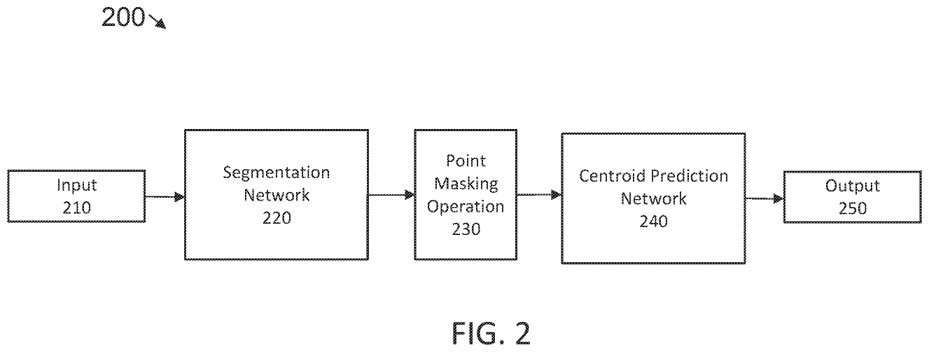

FIG. 2 illustrates a diagram of an example system 200 for improving a centroid prediction (e.g., output 250) of a target object detected by one or more sensors by leveraging data outputs from a segmentation network (e.g., segmentation network 220) and providing the data outputs to a centroid network (e.g., centroid prediction network 240). As shown in FIG. 2, segmentation network 220 can receive input 210. In some examples, input 210 can include point cloud data points detected by one or more sensors. The point cloud data points can correspond to a target detected by one or more sensors. Further, in some scenarios, an object detection algorithm (not shown) can generate one or more bounding boxes around a region of a point cloud estimated to correspond to the target object located within the point cloud data and provide the bounding box (including the point cloud data points located within the bounding box) to segmentation network 220 (as input 210).

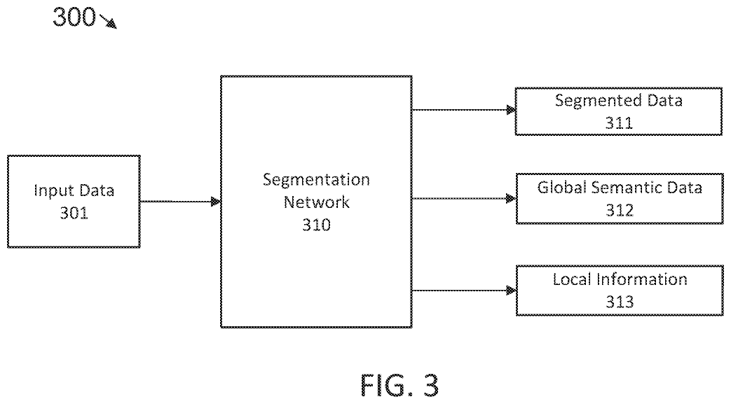

In some cases, the bounding box (including the point cloud data points located within the bounding box) provided to segmentation network 220 (as input 210) can include point cloud sensor data points that do not correspond to the target object (such as point cloud sensor data points corresponding to the background, for example). As discussed above, this can occur since the bounding box can be rectangular in shape, while a detected object may not be rectangular and/or may otherwise differ in shape from the shape of the bounding box. Therefore, some point cloud sensor data points located within a bounding box (and included in input 210) may not correspond to the intended target object located within the bounding box. As discussed in more detail below (with reference to FIG. 3), segmentation network 220 can provide several functions, including segmenting the received point cloud data points to determine which point cloud data points correspond to the target object and which point cloud data points do not correspond to the target object. The output of segmentation network 220 can indicate which point cloud data points correspond to the target object (in addition to other outputs) for subsequent processing by other algorithms and networks. A determination of which point cloud data points correspond to the target object can improve the speed, efficiency, and accuracy of subsequent operations performed on the point cloud data points.

As further explained in more detail below (with reference to FIG. 3), segmentation network 220 can also perform additional functions on the input data (e.g., input 210). For example, segmentation network 220 can associate the segmented point cloud data points with a semantic label that identifies the type of target that is within the bounding area. As also discussed below in more detail, segmentation network 220 can also make determinations about local information related to the individual data points of the point cloud. For example, segmentation network 220 can determine a probability that a given data point corresponds to the target, determine a location of a data point about the target by leveraging RGB information (and image location information) from an image captured by a camera sensor of the same target, and associate each data point of the point cloud data with a specific feature of the target identified by the semantic label. The segmentation network 220 is not limited to these functions and can perform other similar and related functions. Each of these functions performed by segmentation network 220 can be output and leveraged by other systems and networks to assist in object detection, tracking, object recognition, prediction tasks, and/or planning tasks, and others.

As further shown in FIG. 2, the output of segmentation network 220 can be provided to a system to perform a point masking operation 230. In some scenarios, point masking operation 230 can include an operation and/or algorithm that can receive the segmented data points output from segmentation network and apply a mask to some of the point cloud data to remove the data points from the point cloud data that do not correspond to the target. Removing data points that do not correspond to the target (such as, for example, data points that correspond to the background or other objects within the bounding box) can improve subsequent object tracking, prediction tasks, and/or planning tasks by permitting a better understanding of the shape of the target object. Since the data points input to the point masking operation 230 can be the output of the segmentation network 220, the data points that point masking operation 230 processes can include some or all of the semantic and/or local information described above. In some cases, point masking operation 230 can ignore the semantic and/or local information associated with the segmented data points when applying the mask and, after applying the mask to remove the unwanted data points, output the data points corresponding to the target (which can include the semantic and/or local information).

Centroid prediction network 240 can receive the output of the point masking operation 230. In some scenarios, the output of the point masking operation 230 can include point cloud data points corresponding to a target and can optionally also include semantic and/or local information (e.g., rather than merely the raw point cloud data captured by the one or more sensors). This output (e.g., point cloud data points corresponding to a target as well as semantic and/or local information) can be provided as input to a centroid prediction network 240. The centroid prediction network 240 can determine the centroid of a detected target based on the input point cloud data. In some cases, the centroid prediction network 240 can determine a centroid of a target based on raw point cloud data. However, raw point cloud data can include data points that may not correspond to the target (such as background, for example), and therefore the determined centroid may not be correct. It can therefore improve the accuracy and efficiency of the centroid network 240 to provide the segmented point cloud data (that more accurately corresponds to the target) determined by segmentation network 220 to the centroid network 240. By providing a point cloud that more accurately corresponds to the target, the centroid network 240 can determine the centroid of the target more accurately.

Providing the centroid network 240 with semantic and/or local information related to the point cloud data (that was previously determined by segmentation network 220, for example) can also improve the accuracy of the predicted centroid. The semantic label determined by segmentation network 220 (or any other network) can be provided to the centroid network 240 so that the centroid network 240 can make a more informed determination of the centroid location. For example, if the semantic information indicates that the target is a vehicle, the centroid prediction network 240 can use models that more accurately determine the centroid based on unique features of vehicles. Similarly, if the semantic information indicates that the target is a human, the centroid prediction network 240 can use models that more accurately determine the centroid based on unique features of humans. Further, local information such as a probability that a given data point corresponds to the target, a location of a data point about the target based on red, green, blue (RGB) information (and image location information) from an image captured by a camera sensor of the same target, and/or specific feature of the target identified by the semantic label can be useful to the centroid prediction network 240 in making a more accurate centroid prediction. The centroid prediction can be output by the centroid prediction network 240 (e.g., output 250), and this centroid prediction output can be used by other systems and networks to perform tasks such as object tracking, prediction tasks, and/or planning tasks, and others.

FIG. 3 illustrates a diagram of an example system 300 for processing point cloud data (e.g., input data 301) by a segmentation network 310. As shown in FIG. 3, input data 301 can be input into segmentation network 310. In some examples, input data 301 can include point cloud data points detected by one or more sensors. The point cloud data points can correspond to a target detected by one or more sensors. Further, as discussed above, in some scenarios, an object detection algorithm (not shown) can generate one or more bounding boxes around a region of a point cloud estimated to correspond to the target object located within the point cloud data and provide the bounding box (including the point cloud data points located within the bounding box) to segmentation network 310 (as input 301).

As discussed above, in some cases, the bounding box can be a rectangular shape, while a detected object may not be rectangular or may otherwise differ in shape. Therefore, some point cloud sensor data points located within a bounding box (and included in input 301) may not correspond to the intended target object located within the bounding box. Segmentation network 310 can therefore segment the received point cloud data points to determine which point cloud data points correspond to the target object and which point cloud data points do not correspond to the target object. As shown in FIG. 3, one of the outputs of segmentation network 310 can be segmented data 311, which denotes which point cloud data points correspond to the target object. Further, segmentation network 310 can output global semantic data 312 and local information 313. Global semantic data 312 can include a semantic label that identifies the type of object captured by the point cloud data. Local information 313 can include, but is not limited to, data point intensity (e.g., intensity values), corresponding RGB information (obtained from a camera image of the same target, for example), feature information (such as, which portion of the identified target a particular data point corresponds to), and/or position information (such as the position of the target in the environment).

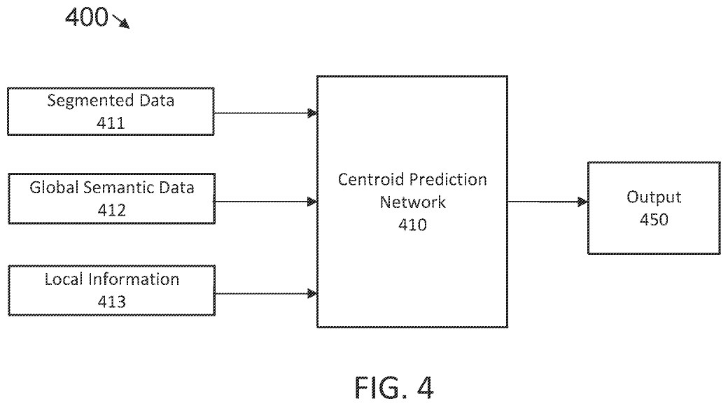

FIG. 4 illustrates a diagram of an example system 400 for processing point cloud data (e.g., segmented data 411, global semantic data 412, and/or local information 413) by a centroid predication network 410 to determine a centroid (e.g., output 450) of a target corresponding to the point cloud data. As shown in FIG. 4, the centroid predication network 410 can receive one or more inputs (e.g., segmented data 411, global semantic data 412, and/or local information 413) and output a centroid (e.g., output 450) of a target corresponding to the point cloud data. As discussed above, the centroid prediction network 410 can determine a centroid of a target based on raw point cloud data. However, raw point cloud data can include data points that may not correspond to the target (such as background, for example), and therefore the determined centroid may not be correct. It can therefore improve the accuracy and efficiency of the centroid network 410 to provide the segmented point cloud data that more accurately corresponds to the target (e.g., segmented data 411) to the centroid network 410. By providing a point cloud that more accurately corresponds to the target, the centroid network 410 can determine the centroid of the target more accurately.

Further, providing the centroid network 410 with global semantic data 412 and/or local information 413 related to the point cloud data can also improve the accuracy of the predicted centroid (e.g., output 450). In some cases, global semantic data 412 can be determined by segmentation network 310 and provided to the centroid network 410 so that the centroid network 410 can make a more accurate determination of the centroid location (more accurate than merely based on the raw point cloud data, for example). Further, local information 413 (such as, for example, a probability that a given data point corresponds to the target, a location of a data point about the target based on RGB information (and image location information) from an image captured by a camera sensor of the same target, and/or specific feature of the target identified by the semantic label) can all be used to improve the centroid prediction (e.g., output 450). The centroid prediction can be output by the centroid prediction network 240 (e.g., output 450), and this centroid prediction output can be subsequently used by other systems and networks to perform object tracking, prediction tasks, and/or planning tasks, and other functions.

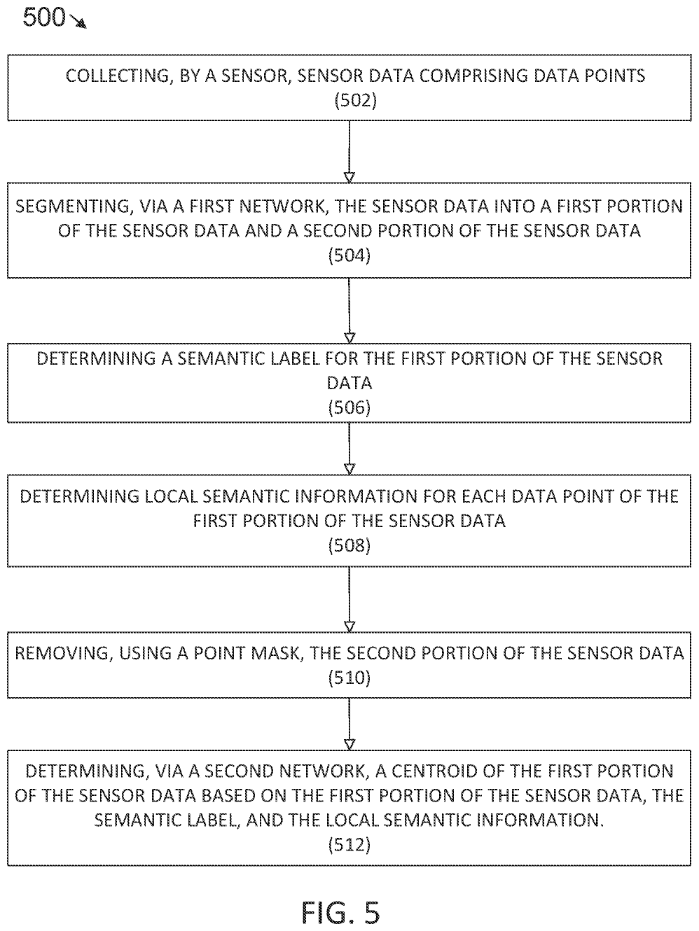

FIG. 5 illustrates a flow diagram of an example process 500 for improving a centroid prediction of a target detected by one or more sensors by leveraging data outputs from a segmentation network and providing the data to a centroid network. At block 502, the process 500 can include collecting, by a sensor (such as, for example, one or more camera sensors, LIDAR sensors, etc.), sensor data comprising data points (e.g., point cloud data points). In one example, a LIDAR sensor can be used to determine ranges (variable distance) of one or more targets by directing a laser to a surface of a target and measuring the time for light reflected from the surface to return to the LIDAR sensor. This raw sensor data collected by the LIDAR sensor can include point cloud data points that can subsequently be analyzed by one or more computing systems or networks to make determinations about the size, shape, and location of the one or more targets (among other determinations).

At block 504, the process 500 can include segmenting, via a first network (e.g., segmentation network 210), the sensor data (e.g., point cloud data points) into a first portion of the sensor data (e.g., point cloud data points corresponding to a target) and a second portion of the sensor data (e.g., point cloud data points that do not correspond to a target). For example, segmentation network 310 can segment the received point cloud data points to determine which point cloud data points correspond to the target object and which point cloud data points do not correspond to the target object. As explained with reference to FIG. 3, one of the outputs of segmentation network 310 can be segmented data 311, which denotes which point cloud data points correspond to at least a portion of the target object. At block 506, the process 500 can include determining a semantic label (e.g., global semantic data 312) for the first portion of the sensor data. For example, segmentation network 310 can associate the segmented point cloud data points with a semantic label that identifies the type of target. As explained with reference to FIG. 3, one of the outputs of segmentation network 310 can be global semantic data 312.

At block 508, the process 500 can include determining local semantic information (e.g., local information 313) for each data point of the first portion of the sensor data. For example, segmentation network 310 can also make determinations about local information related to the individual data points of the point cloud. Segmentation network 310 can determine a probability that a given data point corresponds to the target, determine a location of a data point about the target by leveraging RGB information (and image location information) from an image captured by a camera sensor of the same target, and associate each data point of the point cloud data with a specific feature of the target identified by the semantic label. The local information 313 is not limited to these examples, and can include any information associated with individual points of the cloud data points.

At block 510, the process 500 can include removing, using a point mask (e.g., point masking operation 230), the second portion of the sensor data (e.g., point cloud data points that do not correspond to a target). In some scenarios, point masking operation 230 can include an operation and/or algorithm that can receive the segmented data points output from segmentation network and apply a mask to the point cloud data to remove the data points from the point cloud data that do not correspond to the target. Removing data points that do not correspond to the target (such as, for example, data points that correspond to the background or other objects within the bounding box) can improve subsequent object tracking, prediction tasks, and/or planning tasks by permitting a better understanding of the shape of the target object. Since the data points input to the point masking operation 230 can be the output of a segmentation network, the data points that point masking operation 230 processes can include all of the semantic and/or local information described above. In some cases, point masking operation 230 can ignore the semantic and/or local information associated with the segmented data points when applying the mask and, after applying the mask to remove the unwanted data points, output the data points corresponding to the target (which can include the semantic and/or local information).

At block 510, the process 500 can include determining, via a second network (e.g., centroid prediction network 240), a centroid of the first portion of the sensor data based on the first portion of the sensor data (e.g., segmented data 411), the semantic label (e.g., global semantic data 412), and the local semantic information (e.g., local information 413). As explained with reference to FIG. 4 above, the centroid predication network 410 can receive one or more inputs (e.g., segmented data 411, global semantic data 412, and/or local information 413) and output a centroid (e.g., output 450) of a target corresponding to the point cloud data. It can improve the accuracy and efficiency of the centroid network 410 to provide the segmented point cloud data that more accurately corresponds to the target (e.g., segmented data 411) to the centroid network 410. By providing a point cloud that more accurately corresponds to the target, the centroid network 410 can determine the centroid of the target more accurately. Additionally, providing the centroid network 410 with global semantic data 412 and/or local information 413 related to the point cloud data can also improve the accuracy of the predicted centroid (e.g., output 450). Further, local information 413 (such as, for example, a probability that a given data point corresponds to the target, a location of a data point about the target based on RGB information (and image location information) from an image captured by a camera sensor of the same target, and/or specific feature of the target identified by the semantic label) can all be used to improve the centroid prediction (e.g., output 450). The centroid prediction can be output by the centroid prediction network 240 (e.g., output 450), and this centroid prediction output can be subsequently used by other systems and networks to perform object tracking, prediction tasks, and/or planning tasks, and other functions.

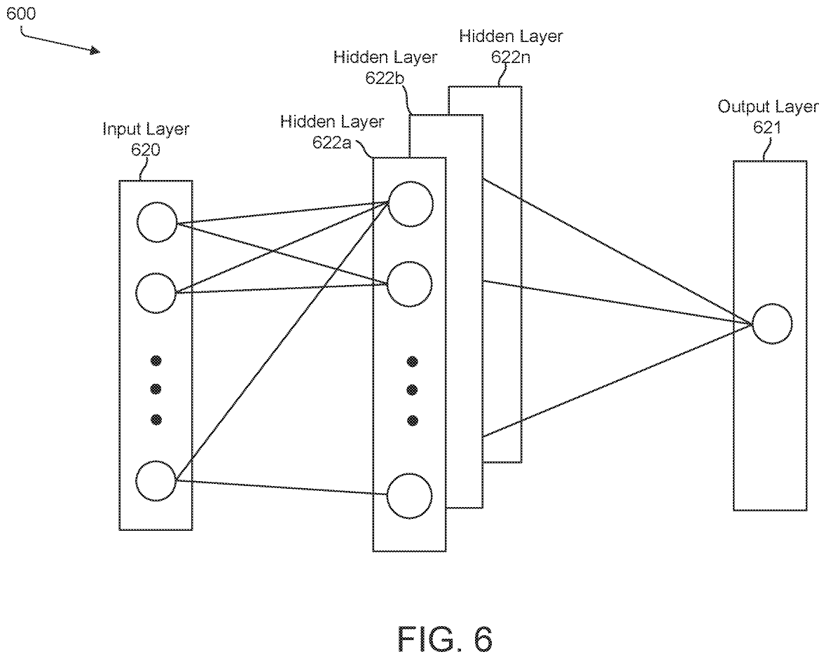

In FIG. 6, the disclosure now turns to a further discussion of models that can be used to implement at least some of the systems and techniques described herein. FIG. 6 is an example of a deep learning neural network 600 that can be used to implement all or a portion of the systems and techniques described herein (e.g., neural network 600 can be used to implement a segmentation network and/or a centroid prediction network for improving a centroid prediction of a target object detected by one or more sensors, as discussed above). An input layer 620 can be configured to receive sensor data and/or data relating to an environment surrounding an AV. Neural network 600 includes multiple hidden layers 622a, 622b, through 622n. The hidden layers 622a, 622b, through 622n include “n” number of hidden layers, where “n” is an integer greater than or equal to one. The number of hidden layers can be made to include as many layers as needed for the given application. Neural network 600 further includes an output layer 621 that provides an output resulting from the processing performed by the hidden layers 622a, 622b, through 622n.

Neural network 600 is a multi-layer neural network of interconnected nodes. Each node can represent a piece of information. Information associated with the nodes is shared among the different layers and each layer retains information as information is processed. In some cases, the neural network 600 can include a feed-forward network, in which case there are no feedback connections where outputs of the network are fed back into itself. In some cases, the neural network 600 can include a recurrent neural network, which can have loops that allow information to be carried across nodes while reading in input.

Information can be exchanged between nodes through node-to-node interconnections between the various layers. Nodes of the input layer 620 can activate a set of nodes in the first hidden layer 622a. For example, as shown, each of the input nodes of the input layer 620 is connected to each of the nodes of the first hidden layer 622a. The nodes of the first hidden layer 622a can transform the information of each input node by applying activation functions to the input node information. The information derived from the transformation can then be passed to and can activate the nodes of the next hidden layer 622b, which can perform their own designated functions. Example functions include convolutional, up-sampling, data transformation, and/or any other suitable functions. The output of the hidden layer 622b can then activate nodes of the next hidden layer, and so on. The output of the last hidden layer 622n can activate one or more nodes of the output layer 621, at which an output is provided. In some cases, while nodes in the neural network 600 are shown as having multiple output lines, a node can have a single output and all lines shown as being output from a node represent the same output value.

In some cases, each node or interconnection between nodes can have a weight that is a set of parameters derived from the training of the neural network 600. Once the neural network 600 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 600 to be adaptive to inputs and able to learn as more and more data is processed.

The neural network 600 is pre-trained to process the features from the data in the input layer 620 using the different hidden layers 622a, 622b, through 622n in order to provide the output through the output layer 621.

In some cases, the neural network 600 can adjust the weights of the nodes using a training process called backpropagation. A backpropagation process can include a forward pass, a loss function, a backward pass, and a weight update. The forward pass, loss function, backward pass, and parameter/weight update is performed for one training iteration. The process can be repeated for a certain number of iterations for each set of training data until the neural network 600 is trained well enough so that the weights of the layers are accurately tuned.

To perform training, a loss function can be used to analyze error in the output. Any suitable loss function definition can be used, such as a Cross-Entropy loss. Another example of a loss function includes the mean squared error (MSE), defined as E_total=Σ(1/2 (target−output)\hat{ }2). The loss can be set to be equal to the value of E_total.

The loss (or error) will be high for the initial training data since the actual values will be much different than the predicted output. The goal of training is to minimize the amount of loss so that the predicted output is the same as the training output. The neural network 600 can perform a backward pass by determining which inputs (weights) most contributed to the loss of the network, and can adjust the weights so that the loss decreases and is eventually minimized.

The neural network 600 can include any suitable deep network. One example includes a Convolutional Neural Network (CNN), which includes an input layer and an output layer, with multiple hidden layers between the input and out layers. The hidden layers of a CNN include a series of convolutional, nonlinear, pooling (for downsampling), and fully connected layers. The neural network 600 can include any other deep network other than a CNN, such as an autoencoder, Deep Belief Nets (DBNs), Recurrent Neural Networks (RNNs), and transformers, among others.

As understood by those of skill in the art, machine-learning based classification techniques can vary depending on the desired implementation. For example, machine-learning classification schemes can utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to: a Stochastic Gradient Descent Regressor, a Passive Aggressive Regressor, etc.

Machine learning classification models can also be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor. Additionally, machine-learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

FIG. 7 illustrates an example processor-based system with which some aspects of the subject technology can be implemented. For example, processor-based system 700 can be any computing device making up, or any component thereof in which the components of the system are in communication with each other using connection 705. Connection 705 can be a physical connection via a bus, or a direct connection into processor 710, such as in a chipset architecture. Connection 705 can also be a virtual connection, networked connection, or logical connection.

In some embodiments, computing system 700 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 700 includes at least one processing unit (Central Processing Unit (CPU) or processor) 710 and connection 705 that couples various system components including system memory 715, such as Read-Only Memory (ROM) 720 and Random-Access Memory (RAM) 725 to processor 710. Computing system 700 can include a cache of high-speed memory 712 connected directly with, in close proximity to, or integrated as part of processor 710.

Processor 710 can include any general-purpose processor and a hardware service or software service, such as services 732, 734, and 736 stored in storage device 730, configured to control processor 710 as well as a special-purpose processor where software instructions are incorporated into the actual processor design. Processor 710 may essentially be a completely self-contained computing system, containing multiple cores or processors, a bus, memory controller, cache, etc. A multi-core processor may be symmetric or asymmetric.

To enable user interaction, computing system 700 includes an input device 745, which can represent any number of input mechanisms, such as a microphone for speech, a touch-sensitive screen for gesture or graphical input, keyboard, mouse, motion input, speech, etc. Computing system 700 can also include output device 735, which can be one or more of a number of output mechanisms known to those of skill in the art. In some instances, multimodal systems can enable a user to provide multiple types of input/output to communicate with computing system 700. Computing system 700 can include communications interface 740, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 740 may also include one or more Global Navigation Satellite System (GNSS) receivers or transceivers that are used to determine a location of the computing system 700 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 730 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Atatic RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L #), Resistive RAM (RRAM/ReRAM), Phase Change Memory (PCM), Spin Transfer Torque RAM (STT-RAM), another memory chip or cartridge, and/or a combination thereof.

Storage device 730 can include software services, servers, services, etc., that when the code that defines such software is executed by the processor 710, it causes the system 700 to perform a function. In some embodiments, a hardware service that performs a particular function can include the software component stored in a computer-readable medium in connection with the necessary hardware components, such as processor 710, connection 705, output device 735, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

Aspect 1. A system comprising: at least one memory; and at least one processor coupled to the at least one memory, the at least one processor configured to: collect, from a sensor, sensor data comprising data points; segment, via a first network, the sensor data into a first portion of the sensor data and a second portion of the sensor data, wherein at least part of the first portion of the sensor data represents data associated with a target; determine a semantic label for the first portion of the sensor data; determine local semantic information for each data point of the first portion of the sensor data; remove, using a point mask, the second portion of the sensor data; and determine, via a second network, a centroid of the first portion of the sensor data based on the first portion of the sensor data, the semantic label, and the local semantic information.

Aspect 2. The system of Aspect 1, wherein the local semantic information includes at least one of red, green, blue (RGB) information; feature information; and position information.

Aspect 3. The system of Aspect 1 or 2, wherein the first network comprises a machine learning model.

Aspect 4. The system of any of Aspects 1 to 3, wherein the second network comprises a machine learning model.

Aspect 5. The system of any of Aspects 1 to 4, wherein the sensor is one of a camera sensor, and a LIDAR sensor.

Aspect 6. The system of any of Aspects 1 to 5, wherein the semantic label identifies a type of object captured by the first portion of the sensor data.

Aspect 7. The system of any of Aspects 1 to 6, wherein the determined centroid is provided to a third network to perform one of object prediction and object planning.

Aspect 8. A method comprising: collecting, from a sensor, sensor data comprising data points; segmenting, via a first network, the sensor data into a first portion of the sensor data and a second portion of the sensor data, wherein at least part of the first portion of the sensor data represents data associated with a target; determining a semantic label for the first portion of the sensor data; determining local semantic information for each data point of the first portion of the sensor data; removing, using a point mask, the second portion of the sensor data; and determining, via a second network, a centroid of the first portion of the sensor data based on the first portion of the sensor data, the semantic label, and the local semantic information.

Aspect 9. The method of Aspect 8, wherein the local semantic information includes at least one of red, green, blue (RGB) information; feature information; and position information.

Aspect 10. The method of Aspect 8 or 9, wherein the first network comprises a machine learning model.

Aspect 11. The method of any of Aspects 8 to 10, wherein the second network comprises a machine learning model.

Aspect 12. The method of any of Aspects 8 to 11, wherein the sensor is one of a camera sensor, and a LIDAR sensor.

Aspect 13. The method of any of Aspects 8 to 12, wherein the semantic label identifies a type of object captured by the first portion of the sensor data.

Aspect 14. The method of any of Aspects 8 to 13, wherein the determined centroid is provided to a third network to perform one of object prediction and object planning.

Aspect 15. A non-transitory computer-readable storage medium comprising at least one instruction for causing a computer or processor to: collect, from a sensor, sensor data comprising data points; segment, via a first network, the sensor data into a first portion of the sensor data and a second portion of the sensor data, wherein at least part of the first portion of the sensor data represents data associated with a target; determine a semantic label for the first portion of the sensor data; determine local semantic information for each data point of the first portion of the sensor data; remove, using a point mask, the second portion of the sensor data; and determine, via a second network, a centroid of the first portion of the sensor data based on the first portion of the sensor data, the semantic label, and the local semantic information.

Aspect 16. The non-transitory computer-readable storage medium of Aspect 15, wherein the local semantic information includes at least one of red, green, blue (RGB) information; feature information; and position information.

Aspect 17. The non-transitory computer-readable storage medium of Aspect 15 or 16, wherein the first network comprises a machine learning model.

Aspect 18. The non-transitory computer-readable storage medium of any of Aspects 15 to 17, wherein the second network comprises a machine learning model.

Aspect 19. The non-transitory computer-readable storage medium of any of Aspects 15 to 18, wherein the sensor is one of a camera sensor, and a LIDAR sensor.

Aspect 20. The non-transitory computer-readable storage medium of any of Aspects 15 to 19, wherein the determined centroid is provided to a third network to perform one of object prediction and object planning.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

What is claimed is:

1. A system comprising:
at least one memory; and
at least one processor coupled to the at least one memory, the at least one processor configured to:
collect, from a sensor, sensor data comprising data points;
segment, via a first network, the sensor data into a first portion of the sensor data and a second portion of the sensor data, wherein at least part of the first portion of the sensor data represents data associated with a target;
determine a semantic label for the first portion of the sensor data;
determine local semantic information for each data point of the first portion of the sensor data;
remove, using a point mask, the second portion of the sensor data; and
determine, via a second network, a centroid of the first portion of the sensor data based on the first portion of the sensor data, the semantic label, and the local semantic information.

2. The system of claim 1, wherein the local semantic information includes at least one of red, green, blue (RGB) information; feature information; and position information.

3. The system of claim 1, wherein the first network comprises a machine learning model.

4. The system of claim 1, wherein the second network comprises a machine learning model.

5. The system of claim 1, wherein the sensor is one of a camera sensor, and a LIDAR sensor.

6. The system of claim 1, wherein the semantic label identifies a type of object captured by the first portion of the sensor data.

7. The system of claim 1, wherein the determined centroid is provided to a third network to perform one of object prediction and object planning.

8. A method comprising:
collecting, from a sensor, sensor data comprising data points;
segmenting, via a first network, the sensor data into a first portion of the sensor data and a second portion of the sensor data, wherein at least part of the first portion of the sensor data represents data associated with a target;
determining a semantic label for the first portion of the sensor data;
determining local semantic information for each data point of the first portion of the sensor data;
removing, using a point mask, the second portion of the sensor data; and
determining, via a second network, a centroid of the first portion of the sensor data based on the first portion of the sensor data, the semantic label, and the local semantic information.

9. The method of claim 8, wherein the local semantic information includes at least one of red, green, blue (RGB) information; feature information; and position information.

10. The method of claim 8, wherein the first network comprises a machine learning model.

11. The method of claim 8, wherein the second network comprises a machine learning model.

12. The method of claim 8, wherein the sensor is one of a camera sensor, and a LIDAR sensor.

13. The method of claim 8, wherein the semantic label identifies a type of object captured by the first portion of the sensor data.

14. The method of claim 8, wherein the determined centroid is provided to a third network to perform one of object prediction and object planning.

15. A non-transitory computer-readable storage medium comprising at least one instruction for causing a computer or processor to:
collect, from a sensor, sensor data comprising data points;
segment, via a first network, the sensor data into a first portion of the sensor data and a second portion of the sensor data, wherein at least part of the first portion of the sensor data represents data associated with a target;
determine a semantic label for the first portion of the sensor data;
determine local semantic information for each data point of the first portion of the sensor data;
remove, using a point mask, the second portion of the sensor data; and
determine, via a second network, a centroid of the first portion of the sensor data based on the first portion of the sensor data, the semantic label, and the local semantic information.

16. The non-transitory computer-readable storage medium of claim 15, wherein the local semantic information includes at least one of red, green, blue (RGB) information; feature information; and position information.

17. The non-transitory computer-readable storage medium of claim 15, wherein the first network comprises a machine learning model.

18. The non-transitory computer-readable storage medium of claim 15, wherein the second network comprises a machine learning model.

19. The non-transitory computer-readable storage medium of claim 15, wherein the sensor is one of a camera sensor, and a LIDAR sensor.

20. The non-transitory computer-readable storage medium of claim 15, wherein the determined centroid is provided to a third network to perform one of object prediction and object planning.
